(19) United States
(12) Patent Application Publication
(10) Pub. No.: US 2015/0079454 A1
(43) Pub. Date: Mar. 19, 2015

(54) SINGLE PLANE SEALED ENCLOSURE

(71) Applicant: FORD GLOBAL TECHNOLOGIES, LLC, Dearborn, MI (US)

(72) Inventors: Patrick Daniel Maguire, Ann Arbor, MI (US); Kanchana Pentapati, Rochester Hills, MI (US)

(73) Assignee: FORD GLOBAL TECHNOLOGIES, LLC, Dearborn, MI (US)

(21) Appl. No.: 14/026,543

(22) Filed: Sep. 13, 2013

(51) Int. Cl. H01M 2/10

(52) U.S. Cl. CPC H01M 2/1083; H01M 2220/20
USPC 429/159

(57) ABSTRACT

A battery assembly for an electrified vehicle is disclosed, the battery assembly includes a battery cover and a battery tray that join at a single continuous planar sealing surface around a perimeter of the assembly. The continuous planar sealing surface is disposed at an angle relative to the base.

### TECHNICAL FIELD

The present disclosure relates to a sealable structure to enclose a high voltage battery pack used in an electrified vehicle.

### BACKGROUND

The battery pack of a hybrid electric vehicle is generally rated at 60 volts or above. To achieve the overall battery voltage, the battery consists of multiple lower voltage individual battery cells connected in series to produce the overall battery voltage. Along with the series connection, the battery may consist of multiple groups of batteries connected in parallel to achieve the current and energy requirements for use in the vehicle. The electrical energy in such a battery pack may receive a charge from a generator or an electrical connection to the utility grid, or the battery may deliver a charge to an electric motor, a traction motor, or electrical vehicular accessories. Typically such battery packs also include systems to monitor and control the individual battery cell's condition and operation, including its state of charge, its temperature, its voltage, as well as high-voltage contactors and bus bars for charging and discharging the battery pack.

To achieve the vehicular energy storage requirements, the use of batteries with higher power density employing advanced battery chemistries are often used. The use of the advanced batteries chemistries requires additional considerations to contain and enclose the battery cells. One consideration is that as a by-product of the battery charging and discharging, the battery may produce gases, liquids and solids during the process. It is important to contain and protect the vehicle and passengers from resulting chemical by-products. Also, these advanced batteries may have an appreciable mass which needs to be contained and secured. It is desirable to have access to the cells for service and maintenance.

### SUMMARY

A battery used in a hybrid electric vehicle may contain multiple individual battery cells, that when combined, produce the energy and voltage necessary for the operation of the vehicle. The battery is generally contained in a battery enclosure which is able to be sealed and also able to be opened and accessed to allow for maintenance and refurbishing. The use of a lid which is oriented at a diagonal, and yet contained in a single plane, may provide for improved accessibility. A bulkhead which provides for suitable electrical and thermal connections to the vehicle may also be included.

Here, a fraction battery assembly is described which comprises a tray and a cover. The tray may include a base having at least one wall extending from the base. The at least one wall may define a continuous planar mounting surface around a perimeter of the tray and that is disposed at an angle relative to the base. The cover may be configured to mount against the planar mounting surface, and a plurality of battery cells may be electrically connected and surrounded by the tray and cover.

### BRIEF DESCRIPTION OF THE DRAWINGS

FIG. 1 illustrates a representation of a vehicle with a battery subsystem in which the battery enclosure has a planar sealing surface that intersects the base plane;

FIG. 2 illustrates a side view of a battery enclosure in which the seam is confined to a single plane and the seam plane generally intersects the top or bottom enclosure plane;

FIG. 3 illustrates an exploded view of a battery enclosure in which the seam is confined to a single plane and the seam plane generally intersects the top or bottom enclosure plane;

FIG. 4 illustrates an exploded view of a battery enclosure in which the battery enclosure has a planar sealing surface which intersects the base plane such that the enclosure walls are rotated with respect to an axis;

FIG. 5a illustrates a side view of a cylindrical battery enclosure in which the battery enclosure has a planar sealing surface which intersects the base plane and the cover has contoured surface;

FIG. 5b illustrates an aspect view of a cylinder battery enclosure in which the battery enclosure has a planar sealing surface which intersects the base plane and the cover has contoured surface; and

FIG. 6 illustrates a representation of a T-shaped battery enclosure in which the seam is confined to a parabolic plane.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Vehicle electricity demand has increased, driving the need to supply voltage and current to satisfy the demand. This electricity demand may be for propulsion and for powering accessories. The need for voltage and current in conjunction with vehicle propulsion is especially prevalent in hybrid electric vehicles and vehicles equipped with stop-start technology. This need may be met by increasing the size of the battery. Battery chemistries that provide greater charge densities may be utilized. Due to the vehicle size constraints, engineers are challenged with packaging battery systems in a variety of vehicle models that have a corresponding variety of space available in which to place the battery system.

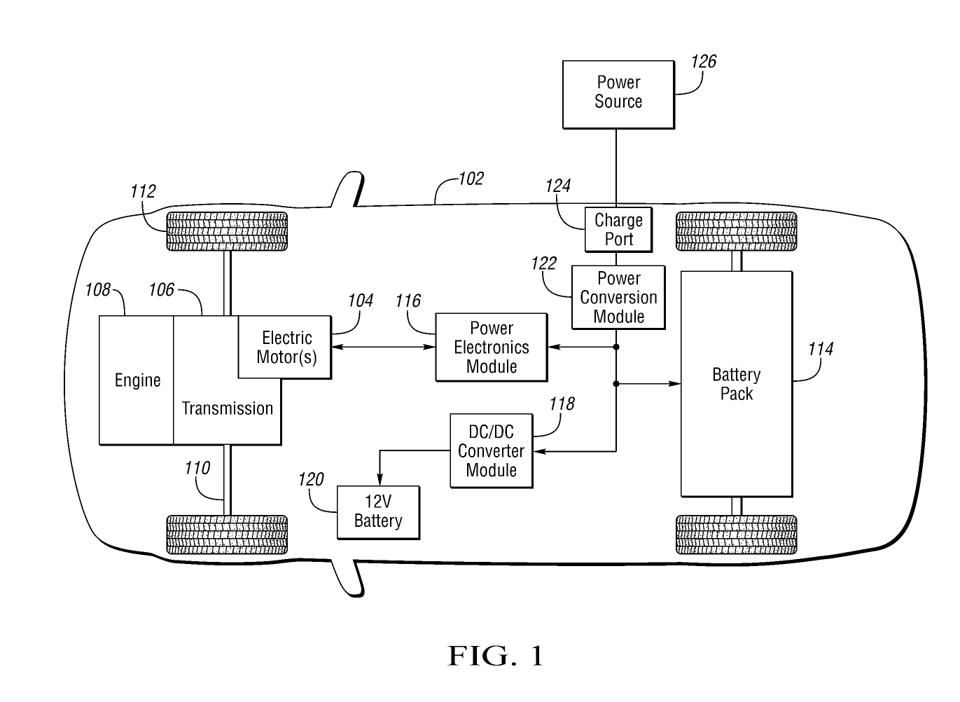

FIG. 1 depicts an example of a plug-in hybrid-electric vehicle. A plug-in hybrid-electric vehicle 102 may comprise one or more electric motors 104 mechanically connected to a hybrid transmission 106. In addition, the hybrid transmission 106 is mechanically connected to an engine 108. The hybrid transmission 106 may also be mechanically connected to a drive shaft 110 that is mechanically connected to the wheels 112. The electric motors 104 can provide propulsion when the engine 108 is turned on. The electric motors 104 can provide deceleration capability when the engine 108 is decoupled. The electric motors 104 may be configured as generators and can provide fuel economy benefits by recovering energy that would normally be lost as heat in the friction braking system. The electric motors 104 may also reduce pollutant emissions since the hybrid electric vehicle 102 may be operated in electric mode under certain conditions.

The battery pack 114 stores energy that can be used by the electric motors 104. A vehicle battery pack 114 typically provides a high voltage DC output. The battery pack 114 is electrically connected to a power electronics module 116. The power electronics module 116 is also electrically connected to the electric motors 104 and provides the ability to bi-directionally transfer energy between the battery pack 114 and the electric motors 104. For example, a typical battery pack 114 may provide a DC voltage while the electric motors 104 may require a three-phase AC current to function. The power electronics module 116 may convert the DC voltage to a three-phase AC current as required by the electric motors 104. In a regenerative mode, the power electronics module 116 will convert the three-phase AC current from the electric motors 104 acting as generators to the DC voltage required by the battery pack 114. The methods described herein are equally applicable to a pure electric vehicle or any other device using a battery pack.

In addition to providing energy for propulsion, the battery pack 114 may provide energy for other vehicle electrical systems. A typical system may include a DC/DC converter module 118 that converts the high voltage DC output of the battery pack 114 to a low voltage DC supply that is compatible with other vehicle loads. Other high voltage loads, such as compressors and electric heaters, may be connected directly to the high-voltage bus from the battery pack 114. In a typical vehicle, the low voltage systems are electrically connected to a 12V battery 120. An all-electric vehicle may have a similar architecture but without the engine 108.

The battery pack 114 may be recharged by an external power source 126. The external power source 126 may provide AC or DC power to the vehicle 102 by electrically connecting through a charge port 124. The charge port 124 may be any type of port configured to transfer power from the external power source 126 to the vehicle 102. The charge port 124 may be electrically connected to a power conversion module 122. The power conversion module may condition the power from the external power source 126 to provide the proper voltage and current levels to the battery pack 114. In some applications, the external power source 126 may be configured to provide the proper voltage and current levels to the battery pack 114 and the power conversion module 122 may not be necessary. The functions of the power conversion module 122 may reside in the external power source 126 in some applications.

In addition to illustrating a plug-in hybrid vehicle, FIG. 1 can illustrate a battery electric vehicle (BEV) if components 108, 122, 124, and 126 are removed. Likewise, FIG. 1 can illustrate a traditional hybrid electric vehicle (HEV) or a power-split hybrid electric vehicle if components 122, 124, and 126 are removed.

A battery system typically comprises a plurality of electrochemical cells. These cells may be independent from each other so that when servicing or refurbishing a battery, an individual defective cell may be removed and replaced. The electrochemical cells can rupture if subjected to improper operating conditions. In the event that the battery cells rupture, the cells may release liquids, gases, or solids along with heat and pressure. It may be desirable to contain or direct release of the gases and/or other emissions within the enclosure in the event of a rupture or vent. The distinction between rupture and vent is that a rupture is an uncontrolled release of cell material and a vent is a controlled release of cell material.

As battery needs change to address the size, shape, weight and charge densities required by the vehicle, the efficient use of available space and different battery chemistries becomes more critical. Due to the potential types of battery chemistries and the possible different locations where the battery may reside in the vehicle, the need for the enclosure to seal the contents becomes more important. Some batteries may require a seal to maintain a liquid and/or gas tight boundary between the inside of the enclosure and the outside of the enclosure.

A battery may be located in multiple locations in a vehicle. If the battery is mounted outside of the passenger compartment, it is desired that the enclosure protect the interior battery cells from water, contaminants and the elements. If the battery is mounted within the passenger compartment, it is desired to protect the exterior of the battery from any liquid, gas or solid material generated as a by-product of the battery operation or in the event of a battery failure.

Along with physical emissions of gasses, liquids and/or solids, a battery may also generate heat during operation. Some battery chemistries, however, may be more efficient when operating within a specific temperature range. Liquids may thus be used to cool (or heat) the battery such that an optimal temperature range of operation is maintained during operation. To facilitate this, the enclosure may be required to maintain or keep the liquid coolant inside the enclosure and the liquid coolant may pass through a seal. The coolant may circulate inside the enclosure and then through the seal to the exterior where the coolant may be returned to the optimal temperature to maintain the desired operational range. Although it is typically not desirable to have the liquid free-flowing on the battery and contents inside the enclosure, there are exceptions to this such as when a liquid is used that is in direct contact with the battery cells and contents inside the enclosure. The temperature control may also be accomplished by the use of a gas such as air.

When using a gas to thermally control the battery temperature, it may still be important that the battery cells are not exposed to any moisture, humidity or water. The gas regulated battery system may require a seal so that the integrity of a closed loop gas system can be maintained. A concern of this system is that the change in pressure inside the enclosure needs to be regulated. The regulation may be accomplished by the use of a vent or channel to transmit the gas from the battery to the vehicle exterior and away from the cabin interior.

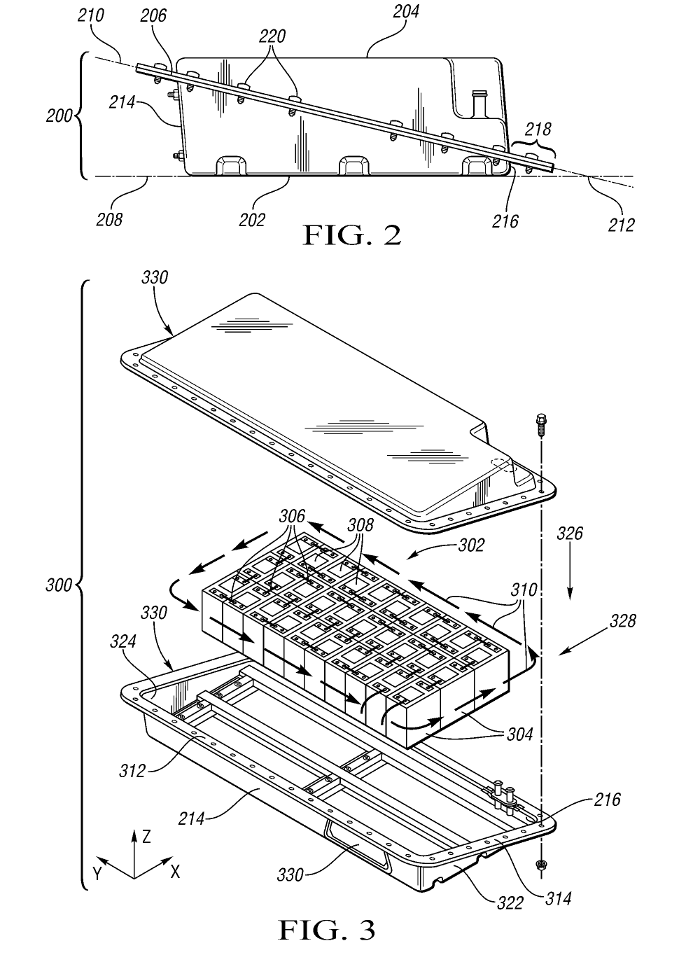

FIG. 2 is a side view of a battery enclosure 200 that comprises a lower section or tray 202 and a top section or cover 204. The tray 202 and cover 204 join together at a seam 206. The tray 202 generally resides on a plane 208. The seam 206 generally resides on a plane 210, where the planes are not parallel but intersect at a line 212. The seam plane 210 can generally be expressed as z=mx+b for all values of y. The tray 202 has a rear wall 214 with a rear wall height of H and a front wall 216 with a reduced height. The intersection point 212 may be determined to maximize the rear wall 214 with respect to the front wall 216 while allowing for a flange 218, which provides for a sealing surface, and the tray 202 to rest flush on the base plane 208. A sealing surface that is confined to a single plane eliminates transitions and improves the reliability and manufacturability of the battery enclosure 200. For battery manufacturers, transitions in the battery cover are more difficult to seal properly. When the transitions go from a vertical wall to a horizontal wall, this increases the difficultly with achieving a quality seal in both directions because compression requirements for such a transition may occur in both vertical and horizontal directions. Here, the force to seal the enclosure can be limited to a single direction. The fasteners 220 may be mounted perpendicular to the seam plane 210 reducing shear stress. The fasteners 220 also may be mounted perpendicular to the base plane 208—either way the force to seal the enclosure 200 is in a single direction. If the fasteners 220 apply force perpendicular to the base plane 208, shear stress is added to the sealing seam 206 in addition to the compression force. Fasteners applying force perpendicular to the base plane 208 would typically be less desirable for the seal 206, but more desirable for the fastener assembly.

FIG. 3 is an exploded view of a battery assembly 300 comprising a battery enclosure 200 that encases the battery pack 302. The battery pack 302 comprises battery cells 304, mechanical and electrical interconnects 306, electronics 308 and thermal paths 310. This battery enclosure 200 is a solution to the sealing problems presented for both a liquid thermally regulated battery system and a gas thermally regulated battery system. The enclosure of FIG. 3 has a battery sealing surface 312 that is inclined with respect to the base plane 208 and forms a continuous sealing surface 314 on a single plane. The base plane 208 is at z=0 for all values of x and y. The planar sealing surface 314 or the mounting surface is contained on a sealing plane 210 that can be expressed as z=mx+b for all values of y. The enclosure is generally a rectangular prism shape which can encapsulate a rectangularly shaped volume. This rectangular battery container has four walls: a back wall 214, a front wall 216 and two transition or side walls 322 and 324. In this illustration, the back wall height is shown to be z=H, and the front wall height is less than H. The reduced height of the front wall 216 allows the battery cells 304 to be accessed from two directions, the z direction 326 and the x direction 328. This two dimensional access makes assembling and servicing the battery easier. The mounting or sealing surface 312 is also confined to a single plane 210. Confining the mounting surface to a single plane 210 in which the sealing surface 312 does not include any breaks produces a continuous planar mounting surface 314. This continuous mounting surface 314 allows a variety of sealing methods to be used. The methods of sealing include, but are not limited to, gasket, O-ring, foam, and silicon bead. Because the planar seam 312 is confined to a single plane 210, the force applied to seal the enclosure 330 is in a single direction. The direction of force to seal the enclosure 330 is generally perpendicular to the sealing plane 210, but that may include instances in which the force is applied perpendicular to the base plane 208 of the enclosure 330.

Another advantage is that the back or high wall 214 can be configured to have an access panel 330. The access panel 330 can be used to allow an electrical connection or conduit through which electricity or thermal energy can be transported. The advantage is that this connection or conduit can be sealed with the battery tray by a more permanent method as the access panel 330 may be opened much less frequently than the enclosure 200.

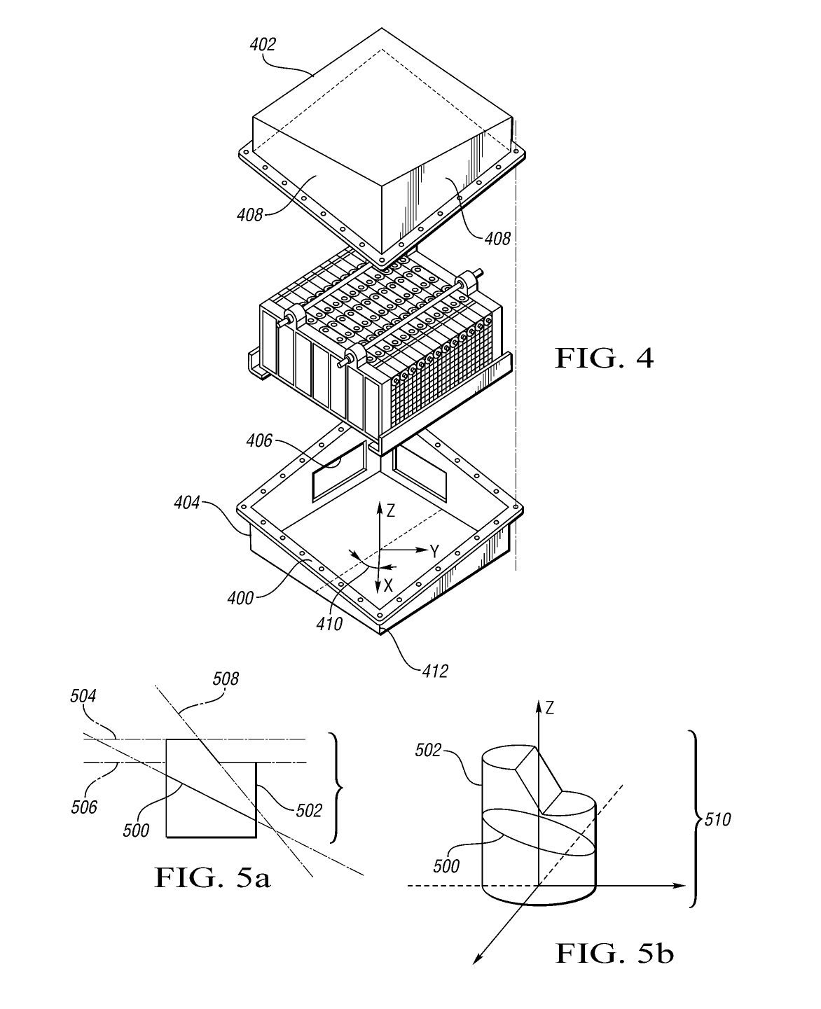

FIG. 4 is an exploded view of an example of an embodiment in which the continuous planar sealing surface 400 can be expressed as z=mx+b. In this example, the battery enclosures comprises of a lid or cover 402 and a tray or base 404. The tray 404 has an access opening 406 to allow for an electrical connection or conduit through which electricity or thermal energy can be transferred. The battery enclosure is rotated such that the walls of the enclosure 408 are not parallel to one of the coordinate axis. The battery enclosure is rotated by a number of degrees 410. The combination of the rotation 410 and the inclined planar sealing surface 400 results in a corner with a lowest height 412.

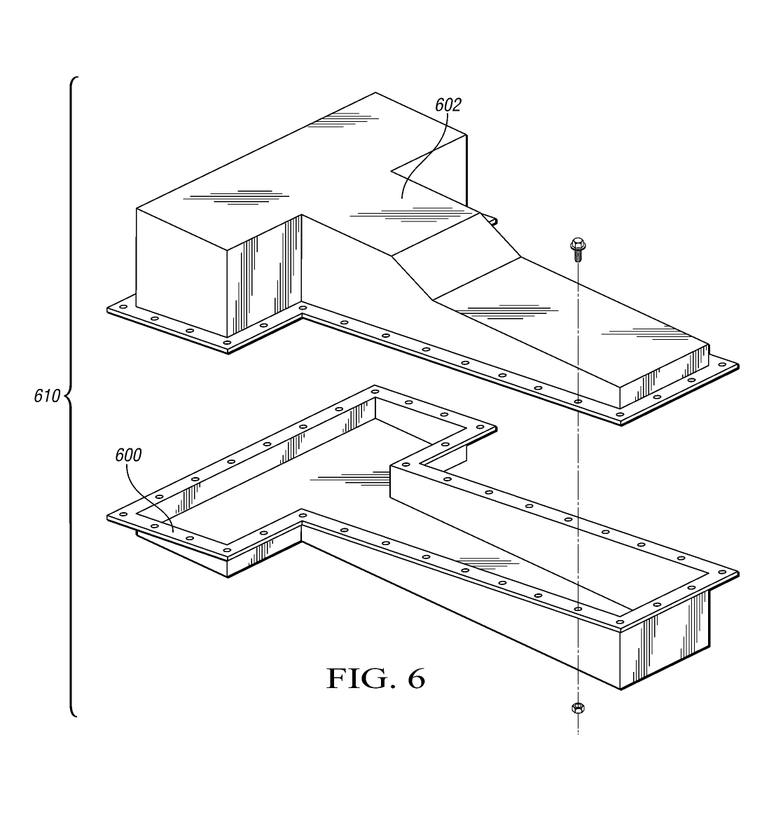

FIG. 5a is side view of an example of an implementation in which the continuous planar sealing surface 500 can also be expressed as z=mx+b. In this example as in others, an enclosure cover 502 does not reside on a single plane but instead may have multiple contours so that the cavity formed can meet the volume and shape needs of the battery system enclosed. In this example, the battery cover 502 generally resides on three planes in which the three planes are illustrated as A-plane 504, B-plane 506 and C-plane 508. The A-plane 504 may be expressed as y=A for all values of x and z. The B-plane 506 may be expressed as y=B for all values of x and z. The C-plane 508 may be expressed as y=mx+b for all values of z. FIG. 5b is an aspect view of a cylinder battery enclosure 510 with a contoured cover 502 and a continuous sealing surface 500.

FIG. 6 is an aspect view of a T-shaped battery enclosure 610 with a contoured cover 602 and a continuous sealing surface 600.

To meet the volume and shape needs of the battery system enclosed, the battery enclosure may have multiple contours so that the cavity formed can meet the volume and shape needs of the battery system enclosed. This may result in the battery enclosure taking the shape of a cylinder, T , L, etc. Also to maximize accessibility, the use of a non-flat plane such as but not limited to a parabolic plane or hyperbolic plane may be used to define the sealing surface such that the surface does not contain any transitions or edges. A smooth parabolic plane or hyperbolic plane sealing surface that eliminates the transitions will improve reliability and manufacturability of the battery enclosure. For battery manufacturers, transitions in the battery cover are more difficult to seal properly. A parabolic plane or hyperbolic plane sealing surface will have a single direction that force can be applied to provide a seal across the entire sealing surface.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated.

While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an electric machine;
a battery tray including edges defining a base and a plurality of walls extending from the edges and defining an inclined continuous planar sealing surface relative to the base around a perimeter of the tray;
a battery cover configured to seal against the planar sealing surface, wherein the battery tray and battery cover define a cavity; and
a plurality of battery cells disposed within the cavity and configured to provide electromotive force to the electric machine.

2. The vehicle of claim 1, wherein the plurality of walls include a front wall and a back wall having a height greater than the front wall and wherein the back wall includes a surface defining an opening sized to permit an electrical connector or conduit to pass therethrough.

3. The vehicle of claim 1, wherein the tray is rectangularly-shaped.

4. The vehicle of claim 1, wherein the tray and cover are cylindrically shaped.

5. The vehicle of claim 1, further comprising at least one fastener mechanically joining the cover and tray such that the force applied by the fastener is generally perpendicular to the sealing surface.

6. A fraction battery assembly comprising:
a tray including a base having at least one wall extending from the base, wherein the at least one wall defines a continuous planar mounting surface around a perimeter of the tray that is disposed at an angle relative to the base;
a cover configured to mount against the planar mounting surface; and
a plurality of battery cells electrically connected and surrounded by the tray and cover.

7. The battery assembly of claim 6, wherein the tray is rectangularly-shaped.

8. The battery assembly of claim 6, wherein the at least one wall has a back portion having a height and a front portion having a height less than the back portion and wherein the back portion defines an opening configured to permit a connector to pass therethrough.

9. The battery assembly of claim 6, wherein tray and cover are T-shaped.

10. The battery assembly of claim 6, wherein the tray and cover are cylindrically shaped.

11. The battery assembly of claim 6, wherein the tray and cover are L-shaped.

12. The battery assembly of claim 6, wherein the cover seals against the mounting surface.

13. A vehicle comprising:
a plurality of walls forming a rectangular battery container having a base and cover, wherein the base and cover interface at a continuous planar seam around a perimeter of the container and wherein the planar seam is oblique relative to any one of the walls; and
a traction battery disposed within the container.

14. The vehicle of claim 13, wherein the plurality of walls includes a back wall having a height and a front wall having a height less than the back wall and wherein the back wall defines an opening sized to permit an electrical connector or conduit to pass therethrough.

15. The vehicle of claim 13, wherein the base is rectangularly-shaped.

16. The vehicle of claim 13, wherein the cover seals against the continuous planar seam.
